(19) United States
(12) Patent Application Publication
(10) Pub. No.: US 2025/0262773 A1
(43) Pub. Date: Aug. 21, 2025

(54) ITEM MANIPULATION SYSTEM AND METHODS

(71) Applicant: Nomagic sp z o.o., Warszawa (PL)

(72) Inventors: Piotr ZAKRZEWSKI, Rzeszów (PL); Mateusz MADEJ, Warszawa (PL); Panagiotis PAPAMANOGLOU, Ludwigshafen (DE); Marek Cygan, Torun (PL)

(21) Appl. No.: 19/054,041

(22) Filed: Feb. 14, 2025

Related U.S. Application Data
(63) Continuation of application No. PCT/IB2023/000541, filed on Aug. 16, 2023.
(60) Provisional application No. 63/371,720, filed on Aug. 17, 2022.

(51) Int. Cl. B25J 9/16; B25J 19/02; G06T 7/60; G06T 7/70

(52) U.S. Cl. CPC B25J 9/1697; B25J 9/163; B25J 9/1669; B25J 19/023; G06T 7/60; G06T 7/70; G06T 2207/20081

(57) ABSTRACT

Provided is an object handling system that may include: an item tilter configured to orient an object; a robot handler configured to place the object into a destination container; and a software module configured instruct the robot handler to move the object to the destination container. Another object handling system may include: an item tilter configured to orient an object; and a software module configured to (i) analyze an orientation of the object and (ii) provide instructions to the item tilter to orient the object to a desired orientation. A method of packing a destination container with an object may include: providing the object to an item tilter; rotating the object, using the item tilter, to a desired orientation; and moving the object into the destination container.

### CROSS REFERENCE

This application is a continuation of International Application No.: PCT/IB2023/000541, filed Aug. 16, 2023, which claims the benefit of U.S. Provisional Patent Application No. 63/371,720, filed Aug. 17, 2022, each of which are entirely incorporated herein by reference for all purposes.

### BACKGROUND

A robotic arm is a type of mechanical arm that may be used in various applications include, for example, automotive, agriculture, scientific, manufacturing, construction, etc. Robotic arms may be programmable and may be able to perform similar functions to a human arm. While robotic arms may be reliable and accurate, often times they may be taught to only perform narrowly defined tasks such as picking a specific type of object from a specific location with a specific orientation. Accordingly, robotic arms are often times programmed to automate execution of repetitive tasks, such as applying paint to equipment, moving goods in warehouses, harvesting crops in a farm field, etc. Robotic arms may comprise links of manipulator that are connected by joints enabling either rotational motion (such as in an articulated robot) or translational (linear) displacement.

A conveyor is a common piece of mechanical handling equipment that may move materials from one location to another. Many kinds of conveying systems are available and are used according to the various needs of different industries. For example, chain conveyors (floor and overhead) may be types of conveying systems. Chain conveyors may include enclosed tracks, I-Beam, towline, power & free, and hand pushed trolleys. Conveyors may offer several advantages, including: increased efficiency, versatility, and cost-effectiveness. While conveyors are widely used and may offer numerous advantages, they also have certain limitations and shortcomings. For example, conveyors operate along a fixed path, which means they may not be suitable for applications that require flexible routing or changes in the material flow direction. Adding flexibility to the system may use additional complex mechanisms or multiple conveyor lines.

A chute is a vertical or inclined plane, channel, or passage through which objects are moved by means of gravity. Chutes are commonly used in various industries for bulk material handling, allowing the controlled transfer of granular or bulky materials from higher to lower levels or between different processing stages. The design of chutes depends on the specific application and the characteristics of the materials being handled. The entry section of the chute is where the material is introduced into the chute from a higher elevation or conveyor. This section is designed to accommodate the flow of material smoothly and prevent any spillage or blockages. Chutes may include features like baffles or flow control gates to regulate the speed and flow of materials through the chute. These features can help prevent material surges and ensure a steady flow. The exit section of the chute is where the material discharges onto the lower level or conveyor. Chutes may be suited for free-flowing. granular, or bulk materials. Chutes may be less suited for handling cohesive materials, sticky substances, or materials with irregular shapes, as this can lead to blockages and flow issues. Depending on the drop height and material characteristics, the material flow in chutes can result in impact forces, potentially leading to material degradation or fines generation. For steeply inclined chutes, there may be limitations in controlling the material flow, leading to faster material acceleration and potentially causing material surges or damage to the chute.

A pusher, in the context of material handling and logistics, refers to a mechanical device or component used to move items or products along a conveyor system or through a production line. The primary function of a pusher is to apply force to push or divert items from one conveyor lane or processing stage to another. Pushers may be used in conveyor systems and automated manufacturing processes to perform tasks. Pushers may be used to divert products from the main conveyor line to specific side lanes or different processing stages. This enables the sorting and distribution of items based on certain criteria, such as destination, size, or product type. Pushers may be employed in sorting systems to direct items to different designated destinations or shipping lanes based on predetermined criteria. Pushers may be used to stage items or products for further processing or packaging. Pushers can transfer products between conveyors or equipment in a production line, facilitating the smooth flow of materials. At very high speeds, pushers may not have enough time to properly engage with and push items, leading to sorting or diverting errors. Achieving precise positioning and alignment of products for proper pushing can be challenging, especially with varying sizes or misaligned items. For applications involving complex sorting patterns or multiple destination lanes, the design and synchronization of multiple pushers can become intricate.

### SUMMARY

Provided herein are embodiments of an object handling system comprising: an item tilter configured to orient an object; a robot handler configured to place the object into a destination container; and a software module configured to instruct the robot handler to move the object to the destination container. In some embodiments, the software module is configured to analyze one or more characteristics of the object. In some embodiments, the software module is configured to instruct the robot handler to move the object from the item tilter to the destination container based at least in part on the analysis of the one or more characteristics of the object. In some embodiments, the software module is configured to determine if the object tilter should orient the object based at least in part on the analysis of the one or more characteristics of the object. In some embodiments, the software module is configured to determine if the object should be placed on the object tilter based at least in part on the analysis of the one or more characteristics of the object. In some embodiments, the software module is configured perform the analysis of the one or more characteristics of the object using a machine learning model. In some embodiments, the object handling system further comprises a database configured to store the one or more characteristics of the object. In some embodiments, the one or more characteristics of the object comprise one or more of: a size of the object, a weight of the object, a shape of the object, or a location of the object. In some embodiments, the software module is further configured to determine a speed at which the object is rotated by the item tilter. In some embodiments, the database is further configured to store a size of the destination container. In some embodiments, the software module is a cloud-based module. In some embodiments, the software module is in operative communication with a computer processor.

Provided herein are embodiments of a method of packing a destination container with an object, comprising: providing the object to an item tilter; rotating the object, using the item tilter, to a desired orientation; and moving the object into the destination container. In some embodiments, providing object to the item tilter is carried out by a conveyor belt, robotic arm, a chute system, a pushing apparatus, or a combination thereof. In some embodiments, moving the object into the destination container is carried out by a conveyor belt, robotic arm, a chute system, a pushing apparatus, or a combination thereof. In some embodiments, the method further comprises determining a placement location of the object within the destination container. In some embodiments, determining the placement location is carried out by a software module operatively connected to a robotic arm. In some embodiments, the software module is operatively connected to a product database corresponding to the object. In some embodiments, the software module is a cloud-based module. In some embodiments, the software module in operative communication with a computer processor. In some embodiments, determining the placement location comprises determining a maximum speed at which the object is able to be conveyed, a speed at which the object is able to be handled by a robotic arm, a force required to manipulate the object, a minimum size packaging for the object, or a combination thereof. In some embodiments, the method further comprises determining to provide the object to the item tilter. In some embodiments, determining to provide the object to the item tilter is based at least in part on output from a product database corresponding to the object or a machine learning model.

In some embodiments, provided herein is an object handling system comprising: an item tilter configured to orient an object; and a software module configured to (i) analyze an orientation of the object and (ii) provide instructions to the item tilter to orient the object to a desired orientation. In some embodiments, the software module is configured to instruct the item tilter to not orient the object if the object is provided to the item tilter at the desired orientation. In some embodiments, the software module is operatively coupled to one or more sensors. In some embodiments, the one or more sensors comprise an optical sensor. In some embodiments, the software module in operative communication with a computer processor. In some embodiments, the system further comprises a product database, wherein the product database comprises information related to the object. In some embodiments, the item tilter is provided at a product loading station. In some embodiments, the product loading station is in proximity or adjacent to a loading apparatus, wherein the loading apparatus provides the object to the item tilter. In some embodiments, the loading apparatus comprises a conveyor, a robotic handler, a chute, a pusher, or a combination thereof. In some embodiments, the loading apparatus provides the object and an additional object to the item tilter for simultaneous orientation of the object and the additional object. In some embodiments, the product loading station comprises the item tilter and an additional item tilter. In some embodiments, the product loading station comprises an unloading apparatus to provide the object in proximity to or within a destination container. In some embodiments, the unloading apparatus comprises the item tilter, a conveyor, a robotic handler, a chute, a pusher, or a combination thereof. In some embodiments, one or more sensors are provided at the product loading station. In some embodiments, the one or more sensors comprise an optical sensor. In some embodiments, the optical sensor is in operative communication with the software module and a computer processor, and wherein the software module instructs the unloading apparatus to move the object in proximity to or within a destination container.

Provided herein are embodiments of an object handling system comprising: an item tilter for properly orienting one or more objects; and a robot handler for placing the one or more objects into a destination container. In some embodiments, the system further comprises a database, wherein the database comprises information related to the one or more objects.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts an exemplary object or item and a direction of rotation, according to some embodiments;

FIGS. 2A-2E depict an exemplary method of rotating objects using an item tilter, according to some embodiments;

FIGS. 3A-3F depict another exemplary method of rotating objects using an item tilter, according to some embodiments;

FIGS. 4A-4C depict another exemplary method of rotating objects using an item tilter, according to some embodiments;

FIG. 5 depicts an item tilter as a component of an automated warehouse, according to some embodiments; and

FIG. 6 depicts a computer system that is programmed or otherwise configured as a component of automated handling systems or methods, according to some embodiments.

### DETAILED DESCRIPTION

In some embodiments, provided herein are systems and methods for automation of one or more processes to sort, handle, pick, place, or otherwise manipulate one or more objects of a plurality of objects. The systems and methods may be implemented to replace tasks which may be performed manually or only in a semi-automated fashion. In some embodiments, the system and methods are integrated with machine learning software, such that human involvement may be completely removed over time. In some embodiments, provided herein are system and methods for analyzing and packing one or more items in a container or package. In some embodiments, the container or package is a box. In some embodiments, a surveillance system determines if human intervention is needed for one or more tasks.

Robotic systems, such as a robotic arm or other automated manipulators, may be used for applications involving picking up or moving objects. Picking up and moving objects may involve picking an object from an initial or source location and placing it at a target location. A robotic device may be used to fill a container with objects, create a stack of objects, unload objects from a truck bed, move objects to various locations in a warehouse, and transport objects to one or more target locations. The objects may be of the same type. The objects may comprise a mix of different types of objects, varying in size, mass, material, etc. Robotic systems may direct a robotic arm to pick up objects based on predetermined knowledge of where objects are in the environment. The system may comprise a plurality of robotic arms, wherein each robotic arm is transports objects to one or more target locations.

In some embodiments, an item manipulation system includes a device or apparatus for re-orientation of items or objects. The device for re-orienting an object or item may be referred to herein as an item tilter. In some embodiments, an item tilter is used in conjunction with one or more robotic arms. The item tilter may reorient an object, such that it can be properly handled by a robotic arm. In some embodiments, an item tilter is provided to properly orient an object prior to placement within a container or box. The item tilter may facilitate proper packing of the container or box to maximize the number of items the container may hold or minimize the additional packing/stuffing materials required for shipping of the items within the container.

In some embodiments, a database is provided containing information related to products being handled by automated systems of a facility. In some embodiments, a database comprises information of how each product or object in an inventory should be handled or manipulated by the item tilter and or robotic arms. In some embodiments, a machine learning process dictates and improves upon the handling of a specific product or object. In some embodiments, the machine learning is trained by observation and repetition of a specific product or object being handled by a robot or automated handling system. In some embodiments, the machine learning is trained by observation of a human interaction with a specific object or product.

### I. Item Tilter

An item tilter may be a mechanical device used to tilt or rotate items, loads, or pallets to a specific angle. One use of an item tilter is to reorient materials or products to facilitate easier handling, improve ergonomics, or aid in certain manufacturing or processing operations. The design of an item tilter may include a platform or surface on which the load or item is placed. The platform may be attached to a tilting mechanism that allows controlled tilting or rotation of a load. The tilting action can be achieved through hydraulic, pneumatic, or electric means, depending on the item tilter's design and intended application. Item tilters offer advantages in terms of improving efficiency, reducing manual handling strain, and enhancing the overall material handling process.

In some embodiments, automated systems, which may include robotic arms, handle unpacking items from warehouse bins to cardboard boxes preparing them to be shipped to the final customer. In some instances, the order and position of incoming goods are random. Therefore, items may be initially provided in positions which make it very difficult to place the item in the destination box in the position that optimizes the volume occupied inside the target box. In some embodiments, an item tilter is provided at a good-to-robot station wherein items are provided to a robot for picking and manipulation. The item tilter may facilitate proper packing in cases where the robot is unable to place items on their flat side. In some embodiments, the item tilter will reorient they lie flat or oriented in preparation for packing into a final container or box.

In some embodiments, the item tilter does not grasp, clamp, or grip the object being manipulated. In some embodiments, an item tilter which does not perform grasping. gripping, clamping, or similar actions prevents damage to the objects handled by the tilter. In some embodiments, the item tilter comprises a substantially planar surface which the object is placed on. The surface may rotate in a specified direction to properly reorient the object in preparation for packing and/or manipulation by a robot. In some embodiments, the item tilter comprises two substantially planar surfaces, orthogonal to one another. In some embodiments, the object is placed against at both surfaces prior to rotation by the item tilter. In some embodiments, the object is placed only against one surface and gravity assists with abutting the object against the second surface. In some embodiments, the item tilter comprises two or more substantially planar surfaces, wherein connecting surfaces are orthogonal to one another. In some embodiments, the object is placed against at least one surface prior to rotation by the item tilter. In some embodiments, the item tilter is coupled to a product database, as described herein. The product database may relay an appropriate speed of rotation to the item tilter based on characteristics of the object being handled, as to prevent damage, mishandling, or misplacement of the object.

In some embodiments, the item tilter comprises one or more surfaces which grasp, clamp, or otherwise hold the object during rotation. In some embodiments, the item tilter is capable of applying different pressures to hold the object. In some embodiments, the item tilter is coupled to an item database, as described herein. The item database may relay an appropriate pressure based on characteristics of the object being handled, as to prevent damage, mishandling, or misplacement of the object. In some embodiments, a rotating surface of the item tilter comprises a suction effector to retain an object during rotation.

In some embodiments, the item tilter and robots of the system are operatively connected to a product database, programmable logic controller, computer system, or a combination thereof. In some embodiments, the device item tilter provides a ready for operation status. In some embodiments, the ready for operation comprises a digital output of ON and signifies when the new item can be placed in the device to be tilted. In some embodiments, the item tilter provides a final position digital output when an item is ready to be picked by an adjacent robot after being rotated into a desired orientation by the item tilter. In some embodiments, the item tilter receives a cycle start indication when rotation of the item is to begin. In some embodiments, automated systems described herein may be able to make decisions not to put the item on the tilter based on the product database.

In some embodiments, an item tilter is provided at a product loading station. The product loading station may comprise two or more item tilters. In some embodiments, the product loading station is provided in proximity to or adjacent to a loading apparatus or output thereof. In some embodiments, the loading apparatus provides the object to the item tilter. The loading apparatus may comprise a conveyor, a robotic handler, a chute, a pusher, or a combination thereof. In some embodiments, the loading apparatus provides two or more objects to the item tilter for simultaneous rotation of said two or more objects. In some embodiments, the product loading station comprises two or more item tilters. In some embodiments, an unloading apparatus is provided at the product loading station to move the object into proximity of or place the object inside the destination container. An unloading apparatus may include the item tilter, a conveyor, a robotic handler, a chute, a pusher, or a combination thereof.

In some embodiments, one or more sensors are provided at the product loading station. In some embodiments, a vision system comprising at least one optical sensor is provided at the product loading station. In some embodiments, the vision system identifies one or more characteristics of items or objects provided at the product loading station. In some embodiments, the vision system is in operative communication with the software module and a computer processor. In some embodiments, the software module instructs the unloading apparatus to move the object in proximity to or within a destination container. In some embodiments, the software module is operatively connected to a product database to determine one or more characteristics of an object, as described herein. In some embodiments, the product database provides a desired orientation for an object provided at the product loading station. In some embodiments, automated systems may provide a decision based on the product database whether or not to put an object on the tilter. For example, an item may be deformable, and tilting will not help.

### A. Operation of the Item Tilter

Operation of an item tilter may be understood as a cyclic process, wherein a cycle starts when an object is placed into the item tilter by a robot and a is complete when the object is provided in a final position and the item tilter is ready to receive a subsequent object. In some embodiments, when an object is placed into the item tilter by a robot, a signal is sent from a programmable logic controller (PLC) of the system to start the cycle. During the cycle, item tilter rotates the object, as described herein. In some embodiments, as the item tilter is rotating the object, the robot will pick a second to be placed in the item tilter. In some embodiments, at the end of the cycle, the item is positioned in the final position. In some embodiments, the cycle ends when the device is ready for placing the next item. In some embodiments, the item tilter is ready for placing the next item even if the first one was not removed from the final position. In some embodiments, the robot picks the first object from the final position and places it in the destination container or box, as the second object is being rotated. In some embodiments, an additional robot is utilized, wherein one robot places objects into the item tilter and an additional robot places them into a destination container or box.

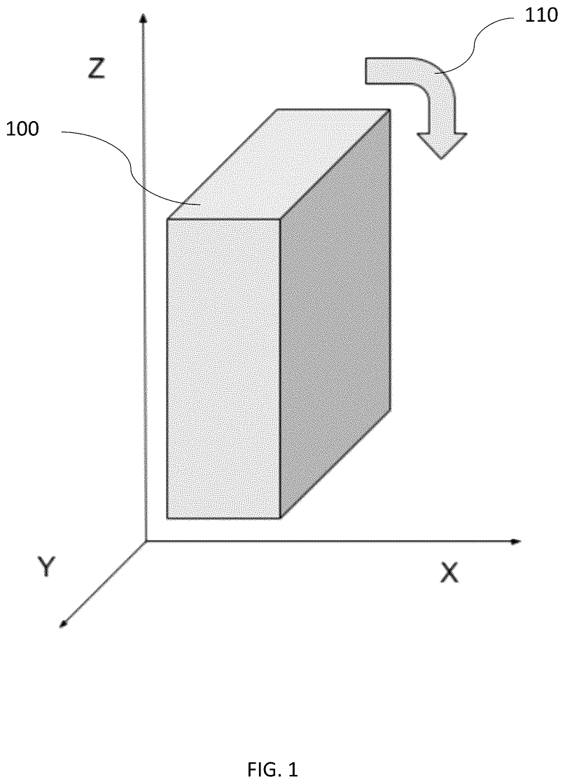

An exemplary object or item 100 and a direction of rotation 110 is depicted in FIG. 1, according to some embodiments. In an example embodiment, consider that the Z-axis is vertical, the Y-axis is the axis of rotation or a parallel to it. In some embodiments, the item 100 may be placed vertically (Z-axis) and should tilt by 90° in the axis parallel to the Y-axis. Therefore, the smallest dimension (at the beginning X-axis) will be oriented in Z-axis after the process. In some embodiments, the position of item 100 after the process is determined utilizing the systems described herein to analyze and identify the object. In some embodiments, the device will assure, by its design positioning of the object, that allows the robot to pick the item from a predetermined location. In some embodiments, at least one extreme point of the item 100 (e.g., corner for cuboidal items) position will be defined within a tolerance range of +/−5 mm for all axes.

In some embodiments, the item tilter is ready to receive the next object for the operation while the previous object is positioned in the final position. In some embodiments. the item tilter is capable of tilting the next item even if the previous item is in the final position, as mentioned above. In some embodiments, the total cycle time as described above should take no more than 0.5, 1, 2, 3, 4, 5, 10, or 15 seconds.

### 1. First Exemplary Rotational Method

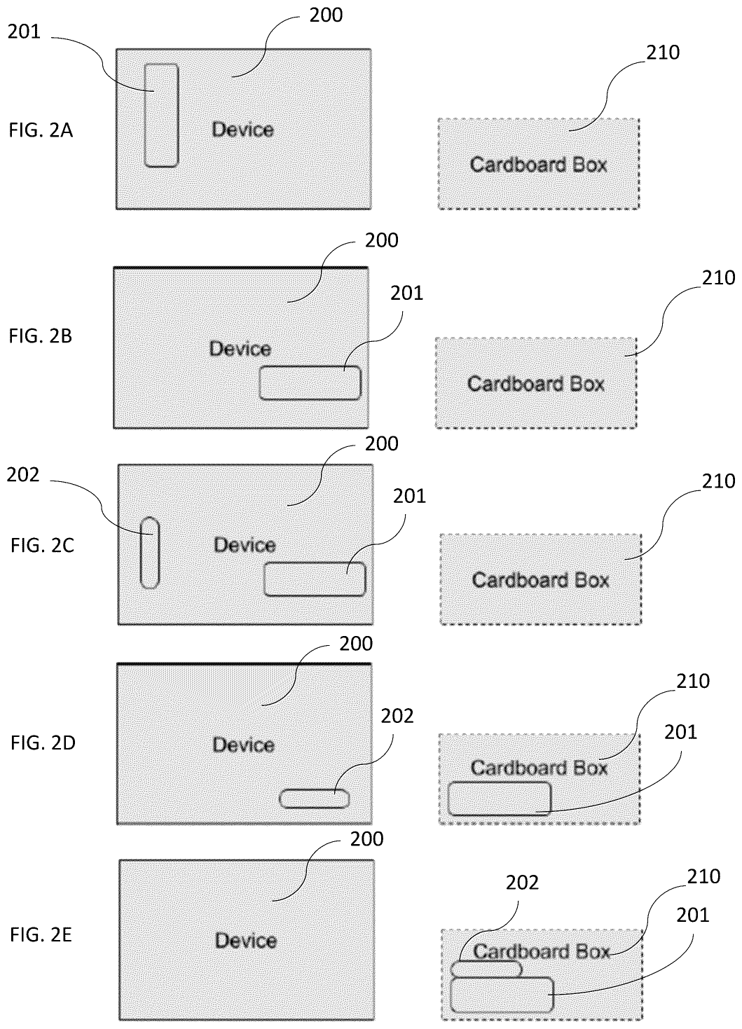

With reference to FIGS. 2A-2E, an exemplary method of rotating objects using an item tilter 200 is depicted, according to some embodiments. In the exemplary method, a robot picks a first item 201 from its final position (after rotation using the item tilter) and places it into a destination container 210 as a second item 202 is being rotated. In some embodiments, the second item 202 is then placed after being rotated. In some embodiments, a third item is rotated as the second item is placed into the destination container. The process may be repeated with subsequent items until the order or destination container is filled.

According to some embodiments, FIG. 2A depicts a first operation, wherein a first item 201 is placed into item tilter 200. According to some embodiments, FIG. 2B depicts a second operation, after first item 201 is rotated by the item tilter 200. According to some embodiments, FIG. 2C depicts a third operation, wherein a second item 202 is placed into item tilter 200. According to some embodiments, FIG. 2D depicts a fourth operation, wherein a second item 202 has been rotated as the first item 201 has been placed into the destination container 210. According to some embodiments, FIG. 2E depicts a fifth operation, wherein a second item 202 has been placed into the destination container 210.

In some embodiments, as depicted in FIGS. 2A-2E, the item tilter orients the items 201, 202, such that they may be properly stacked within the destination container 210 to provide an efficient arrangement with the container 210 or to provide room for subsequent objects.

### 2. Second Exemplary Rotational Method

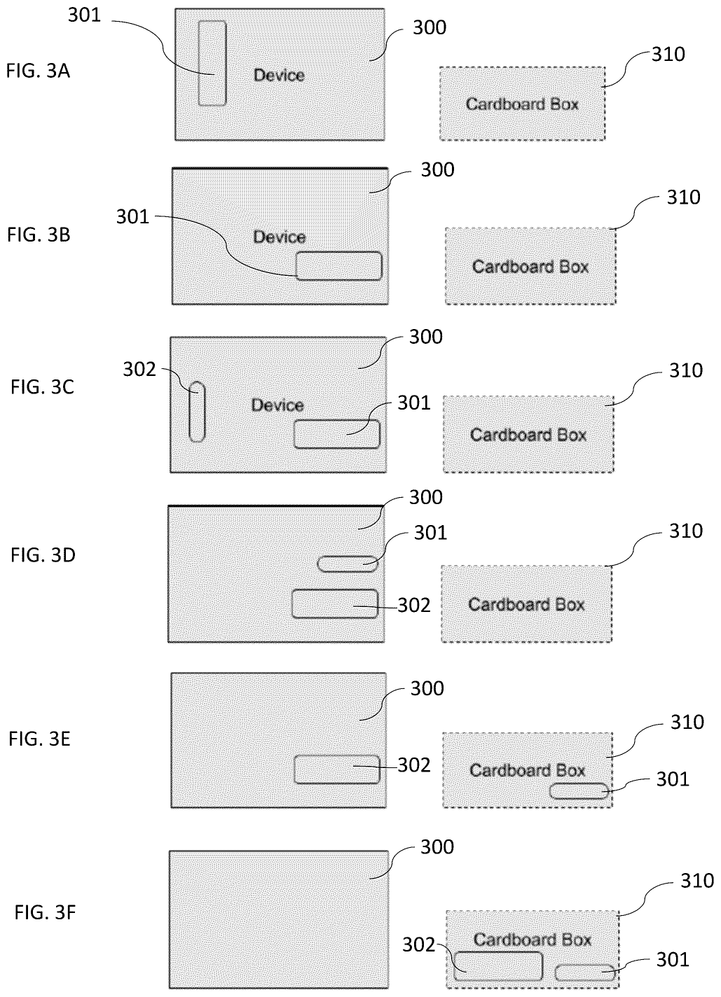

With reference to FIGS. 3A-3F, an exemplary method of rotating objects using an item tilter 300 is depicted, according to some embodiments. In the exemplary method, the item tilter rotates the items 301, 302 prior to placement of the items into a destination container 310 by one or more robots. In some embodiments, the robot is in operative communication with a programmable logic controller, computer system, product database, or a combination thereof. In some embodiments, the robot receives instructions from the programmable logic controller, computer system, product database, or a combination thereof to arrange the one or more items in the destination container after said items have been rotated. In some embodiments, one or more sensors operatively connected are operatively connected to programmable logic controller, computer system, product database, or a combination thereof, and data from the sensors is utilized to properly place the one or more items in said container.

According to some embodiments, FIG. 3A depicts a first operation, wherein a first item 301 is placed into item tilter 300. According to some embodiments, FIG. 3B depicts a second operation, after first item 301 has been rotated by the item tilter 300. According to some embodiments, FIG. 3C depicts a third operation, wherein a second item 302 is placed into item tilter 300. According to some embodiments, FIG. 3D depicts a fourth operation, wherein a second item 302 has been rotated by item tilter 300. According to some embodiments, FIG. 3E depicts a fifth operation, wherein the first item 301 has been placed into the destination container 310. According to some embodiments, FIG. 3F depicts an embodiment wherein a second item 302 has been placed into the destination container 310.

In some embodiments, as depicted in FIGS. 3A-3E, the item tilter orients the items 301, 302, such that they may be properly stacked within the destination container 310 to provide an efficient arrangement with the container 310, or to provide room for subsequent objects. In some embodiments, one or more subsequent items (e.g., a third item, a fourth item, a sixth item, etc.) are placed in the item tilter 300 and rotated prior to placement of all items within container 310. In some embodiments, one or more subsequent items (e.g., a third item, a fourth item, a sixth item, etc.) are placed into the item tilter, rotated, and placed into the destination container after the previous set of items (e.g., the pair of first item 301 and second item 302) are placed into the container. In some embodiments, sets of items are loaded in pairs, trios, quartets, quintets, etc. In some embodiments, item tilter and robot receive instructions from the programmable logic controller, computer system, product database, or a combination thereof to specify the loading order for a destination container.

### 3. Third Exemplary Rotational Method

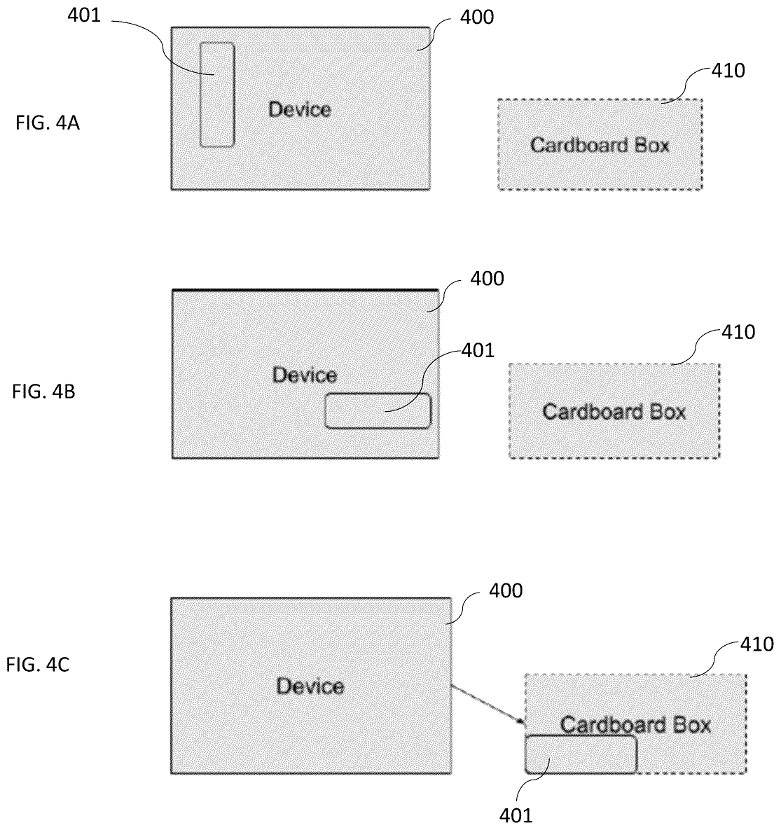

With reference to FIGS. 4A-4C, an exemplary method of rotating objects using an item tilter 400 is depicted, according to some embodiments. In the exemplary method, a robot picks a first item 401 from its final position (after rotation using the item tilter) and places it into a destination container 410 prior to any subsequent items being placed within the destination container. The process may be repeated with subsequent items until the order or destination container is filled.

According to some embodiments, FIG. 4A depicts a first operation, wherein a first item 401 is placed into item tilter 400. According to some embodiments, FIG. 4B depicts a second operation, after first item 401 is rotated by the item tilter 400. According to some embodiments, FIG. 4C depicts a third operation, wherein the first item 401 has been placed into the destination container 410. In some embodiments, item tilter and robot receive instructions from the programmable logic controller, computer system, product database, or a combination thereof to specify the loading placement for each item to be received by the destination container.

### 4. Exemplary Sizing of the Item Tilter

In some embodiments, an item tilter is designed to handle objects having a height (Z-axis), of up to 200 millimeters (mm). In some embodiments, an item tilter is designed to handle objects having a width (Y-axis), of up to 300 mm. In some embodiments, an item tilter is designed to handle objects having a length (X-axis), of up to 200 mm. In some embodiments, the item is provided such that the length (X-axis) of the object corresponds to the smallest dimension of the object. In some embodiments, the item tilter handles objects weighing up to 3 kilograms (kg). In some embodiments, the processes described above are carried out without prior determination of the shape of the object being handled. In some embodiments, the shape of the object being handled is provided by a product database or information gathered by sensors, as described herein.

In some items the destination container comprises dimensions of about 310 mm length, 220 mm width, and 140 mm height. In some items the destination container comprises dimensions of about 410 mm length, 305 mm width, and 195 mm height. In some items the destination container comprises dimensions of about 595 mm length, 395 mm width, and 250 mm height.

### 5. Exemplary Placement of the Item Tilter

In some embodiments, an item tilter is provided as a component of an automated warehouse. In some embodiments, an item tilter is adjacent to one or more conveyor belts. In some embodiments, an item tilter is adjacent to one or more components for automated movement of items. The automated components may include a robotic arm, a conveyor belt or system, a chute system, a pushing apparatus, or a combination thereof.

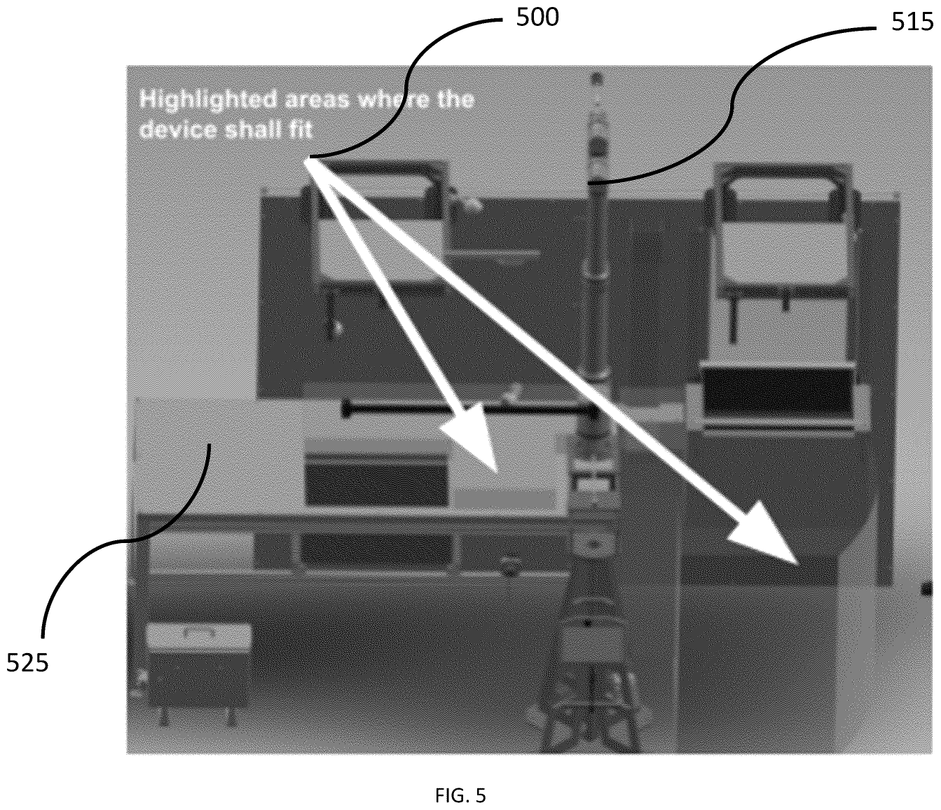

FIG. 5 depicts an item tilter 500 as a component of an automated warehouse, according to some embodiments. In some embodiments, a robotic arm 515 is provided for one or more item tilters 500. In some embodiments, a surface 525 (e.g., a table or bench space) is provided to place items after they have been rotated, but prior to placement within a destination container or box.

### II. Robotic Arms

In some embodiments, one or more robotic manipulators of the system comprise robotic arms. In some embodiments, a robotic arm comprises one or more of robot joints connecting a robot base and an end effector receiver or end effector. A base joint may be configured to rotate the robot arm around a base axis. A shoulder joint may be configured to rotate the robot arm around a shoulder axis. An elbow joint may be configured to rotate the robot arm about an elbow axis. A wrist joint may be configured to rotate the robot arm around a wrist. A robot arm may be a six-axis robot arm with six degrees of freedom. A robot arm may comprise less or more robot joints and may comprise less than six degrees of freedom.

A robot arm may be operatively connected to a controller. The controller may comprise an interface device enabling connection and programming of the robot arm. The controller may comprise a computing device comprising a processor and software or a computer program installed there on. The computing device may can be provided as an external device. The computing device may be integrated into the robot arm.

In some embodiments, the robotic arm can implement a wiggle movement. The robotic arm may wiggle an object to help segment the box from its surroundings. In embodiments, wherein a vacuum end effector is employed, the robotic arm may employ a wiggle motion in order to create a firm seal against the object. In some embodiments, a wiggle motion may be utilized if the system detects that more than one object has been unintendedly handled by the robotic arm. In some embodiments, the robotic arm may release and re-grasp an object at another location if the system detects that more than one object has been unintendedly handled by the robotic arm.

### A. End Effectors

In some embodiments, various end effectors may comprise grippers, vacuum grippers, magnetic grippers, etc. In some embodiments, the robotic arm may be equipped with end effector, such as a suction gripper. In some embodiments, the gripper includes one or more suction valves that can be turned on or off either by remote sensing, single point distance measurement, and/or by detecting whether suction is achieved. In some embodiments, an end effector may include an articulated extension.

In some embodiments, the suction grippers are configured to monitor a vacuum pressure to determine if a complete seal against a surface of an object is achieved. Upon determination of a complete seal, the vacuum mechanism may be automatically shut off as the robotic manipulator continues to handle the object. In some embodiments, sections of suction end effectors may comprise a plurality of folds along a flexible portion of the end effector (i.e., bellow or accordion style folds) such that sections of vacuum end effector can fold down to conform to the surface being gripped. In some embodiments, suction grippers comprise a soft or flexible pad to place against a surface of an object, such that the pad conforms to said surface.

In some embodiments, the system comprises a plurality of end effectors to be received by the robotic arm. In some embodiments, the system comprises one or more end effector stages to provide a plurality of end effectors. Robotic arms of the system may comprise one or more end effector receivers to allow the end effectors to removable attach to the robotic arm. End effectors may include single suction grippers, multiple suction grippers, area grippers, finger grippers, and other end effector types known in the art.

In some embodiments, an end effector is selected to handle an object based on analyzation of one or more images captured by one or more image sensors, as described herein. In some embodiments, the one or more image sensors are cameras. In some embodiments, an end effector is selected to handle an object based on information received by optical sensors scanning a machine-readable code located on the object. In some embodiments, an end effector is selected to handle an object based on information received from a product database, as described herein.

### 6. End Effector Selection

As described herein, a system for surveilling the handling of objects or products within an automated warehouse may be utilized to improve efficiency. In some embodiments, an image sensor is placed before a robotic handler or arm. In some embodiments, the image sensor is in operative communication with a robotic handling system, which resides downstream from the image sensor. In some embodiments, the image sensor determines which product type is on the way or will arrive at the robotic handling system next. Based on the determination of the product, the robotic handling system may select and attach the appropriate end effector to handle the specific product type. Determination of a product type prior to the product reaching the handling station may improve efficiency of the system.

### III. Optical Sensors

### A. Machine-readable Codes

In some embodiments, the system includes one or more optical sensors. The optical sensors may be operatively coupled to at least one processor. In some embodiments, the system comprises data storage comprising instructions executable by the at least one processor to cause the system to perform functions. The functions may include causing the robotic manipulator to move at least one physical object through a designated area in space of a physical. The functions may further include causing one or more optical sensors to determine a location of a machine-readable code on the at least one physical object as the at least one physical object is moved through a target location. Based on the determined location, at least one optical sensor may scan the machine-readable code as the object is moved so as to determine information associated with the object encoded in the machine-readable code.

In some embodiments, information obtained by a machine readable code is referenced to a product database. The product database may provide information corresponding to an object being handled by a robotic manipulator, as described herein. The product database may provide information regarding a target location or position of the object and verify that the object is in a proper location.

In some embodiments, based on the information associated with the object obtained from the machine-readable code, a respective location is determined by the system at which to cause a robotic manipulator to place an object. In some embodiments, based on the information associated with the object obtained from the machine-readable code, the system may place an object at a target location.

In some embodiments, the information comprises proper orientation of an object. In some embodiments, proper orientation is referenced to the surface on which a machine-readable code is provided. Information comprising proper orientation of an object may determine the orientation at which the object is to be placed at the target position or location. Information comprises proper orientation of an object may be used to determine a grasping or handling point at which a robotic manipulator grasps, grips, or otherwise handles the object.

In some embodiments, information associated with an object obtained from at the machine-readable code may be used to determine one or more anomaly events. Anomaly events may include misplacement of the object within a warehouse or within the system. damage to the object, unintentional connection of more than one object, combinations thereof, or other anomalies which would result in an error in placing an object in an appropriate position or otherwise causing an error in further processing to take place.

In some embodiments, the system may determine that the object is at an improper location from the information associated with the object obtained from the machine-readable code. The system may generate an alert that the object is located at an improper location, as described herein. The system may place the object into at an error or exception location. The exception location may be located within a container. In some embodiments, the exception location is designated for objects which have been determined to be at an improper location within the system or within a warehouse.

In some embodiments, information associated with an object obtained from at the machine-readable code may be used to determine one or more properties of the object. The information may include expected dimensions, shapes, or images to be captured. Properties of an object may include an objects size, an objects weight, flexibility of an object, and one or more expected forces to be generated as the object is handled by a robotic manipulator.

In some embodiments, a robotic manipulator comprises the one or more optical sensors. The one or more optical sensors may be physically coupled to a robotic manipulator. In some embodiments, the system comprise multiple cameras oriented at various positions such that when one or more optical sensors are moved over an object, the optical sensors can view multiple surfaces of the object at various angles. Alternatively, the system may comprise multiple mirrors, such that mirrors so that one or more optical sensors can view multiple surfaces of an object. In some embodiments, a system comprises one or more optical sensors located underneath a platform on which the object is placed or moved over during a scanning procedure. The platform may be transparent or semi-transparent so that the optical sensors located underneath it can scan a bottom surface of the object.

In another example configuration, the robotic arm may bring a box through a reading station after or while orienting the box in a certain manner, such as in a manner in order to place the machine-readable code in a position in space where it can be easily viewed and scanned by one or more optical sensors.

### B. Image Sensors

In some embodiments, the one or more optical sensors comprise one or more images sensors. The one or more image sensors may capture one or more images of an object to be handled by a robotic manipulator or an object being handled by the robotic manipulator. In some embodiments, the one or more images sensors comprise one or more cameras. In some embodiments, an image sensor is coupled to a robotic manipulator. In some embodiments, an image sensor is placed near a workstation of a robotic manipulator to capture images of one or more object to be handled by the manipulator. In some embodiments, the image sensor captures images of an object being handled by a robotic manipulator.

In some embodiments, one or more image sensors comprise a depth camera. The depth camera may be a stereo camera, an RGBD (RGB Depth) camera, or the like. The camera may be a color or monochrome camera. In some embodiments, one or more image sensors comprise a RGBaD (RGB+active depth, e.g., an Intel RealSense D415 depth camera) color or monochrome camera registered to a depth sensing device that uses active vision techniques such as projecting a pattern into a scene to enable depth triangulation between the camera or cameras and the known offset pattern projector. In some embodiments, the camera is a passive depth camera. In some embodiments, cues such as barcodes, texture coherence, color, 3D surface properties, or printed text on the surface may also be used to identify an object and/or find its pose in order to know where and/or how to place the object. In some embodiments, shadow or texture differences may be employed to segment objects as well. In some embodiments, an image sensor comprises a vision processor. In some embodiments, an image sensor comprises an inferred stereo sensor system. In some embodiments, an image sensor comprises a stereo camera system.

In some embodiments, a virtual environment including a model of the objects in 2D and/or 3D may be determined and used to develop a plan or strategy for picking up the objects and verifying their properties are an approximate match to the expected properties. In some embodiments, a system uses one or more sensors to scan an environment containing objects. In an embodiment, as a robotic arm moves, a sensor coupled to the arm captures sensor data about a plurality of objects in order to determine shapes and/or positions of individual objects. A larger picture of a 3D environment may be stitched together by integrating information from individual (e.g., 3D) scans. In some embodiments, the image sensors are placed in fixed positions, on a robotic arm, and/or in other locations. According to various embodiments, scans may be constructed and used in accordance with any or all of a number of different techniques.

In some embodiments, scans are conducted by moving a robotic arm upon which one or more image sensors are mounted. Data comprising a position of the robotic arm position may provide be correlated to determine a position at which a mounted sensor is located. Positional data may also be acquired by tracking key points in the environment. In some embodiments, scans may be from fixed-mount cameras that have fields of view (FOVs) covering a given area.

In some embodiments, a virtual environment built using a 3D volumetric or surface model to integrate or stitch information from more than one sensor. This may allow the system to operate within a larger environment, where one sensor may be insufficient to cover a large environment. Integrating information from multiple sensors may yield finer detail than from a single scan alone. Integration of data from multiple sensors may reduce noise levels received by the system. This may yield better results for object detection, surface picking, or other applications.

Information obtained from the image sensors may be used to select one or more grasping points of an object. In some embodiments, information obtained from the image sensors may be used to select an end effector for handling an object.

In some embodiments, an image sensor is attached to a robotic arm. In some embodiments, the image sensor is attached to the robotic arm at or adjacent to a wrist joint. In some embodiments, an image sensor attached to a robotic arm is directed to obtain images of an object. In some embodiments, the image sensor scans a machine-readable code placed on a surface of an object.

### 7. Edge Detection

In some embodiments, the system may integrate edge detection software. One or more captured images may be analyzed to detect and/or locate the edges of an object. The object may be at an initial position prior to being handled by a robotic manipulator or may be in the process of being handled by a robotic manipulator when the images are captured. Edge detection processing may comprise processing one or more two-dimensional images captured by one or more image sensors. Edge detection algorithms utilized may include Canny method detection, first-order differential detection methods, second-order differential detection methods, thresholding, linking, edge thinning, phase congruency methods, phase stretch transformation (PST) methods, subpixel methods (including curve-fitting, moment-based, reconstructive, and partial area effect methods), and combinations thereof. Edge detection methods may utilize sharp contrasts in brightness to locate and detect edges of the captured images.

From the edge detection, the system may record measured dimensional values of an object, as discussed herein. The measured dimensional values may be compared to expected dimensional values of an object to determine if an anomaly event has occurred. Anomaly events based on dimensional comparison may indicate a misplaced object, unintentionally connected objects, damage to an object, or combinations thereof. Determination of an anomaly occurrence may trigger an anomaly event, as discussed herein.

### 8. Image Comparison

In some embodiments, one or more images captured of an object may be compared to one or more references images. A comparison may be conducted by an integrated computing device of the system, as disclosed herein. In some embodiments, the one or more reference images are provided by a product database. Appropriate reference images may be correlated to an object by correspondence to a machine-readable code provided on the object.

In some embodiments, the system may compensate for variations in angles and distance at which the images are captured during the analysis. In some embodiments, an anomaly alert is generated if the difference between one or more captured images of an object and one or more reference images of the object exceeds a predetermined threshold. A difference one or more captured images and one or more reference images may be taken across one or more dimensions or may be a sum difference between the one or more images.

In some embodiments, reference images are sent to an operator during a verification process. The operator may view the one or more references images in relation to the one or more captured images to determine if generation of an anomaly event or alert was correct. The operator may view the reference images in a comparison module. The comparison module may present the reference images side-by-side with the captured images.

### IV. SURVEILLANCE SYSTEM

In some embodiments, provided herein is a surveillance system for monitoring operations and/or product flow in a facility. In some embodiments, the facility comprises at least one automated handling component. In some embodiments, the surveillance system is integrated into an existing warehouse with automated handling systems. In some embodiments, the surveillance system comprises a database of information for each product to be handled in the warehouse. In some embodiments, the database is updated, as described herein.

In some embodiments, the surveillance system comprises at least one image sensor. In some embodiments, the surveillance system allows for identification of a product type. In some embodiments, identification of a product type at one or more points through a product flow in a facility allows for monitoring to determine if the facility is running efficiently and/or if an anomaly has occurred. In some embodiments, the surveillance system allows for determination of an appropriate package size for the one or more products to be placed and packaged within. In some embodiments, the surveillance system allows for automated quality control of products and packaging within a facility.

In some embodiments, an image sensor is provided prior to or upstream from an automated handling station. An image sensor provided prior to an automated handling system may allow for proper preparation by the handling system prior to arrival of a specific product type. In some embodiments, an image sensor provided prior to an automated handling system captures one or more images of a product or object to facilitate determination of an appropriate handler the product should be sent to. In some embodiments, an image sensor provided prior to an automated handling system identifies if a product has been misplaced and/or will not be able to be handled by an automated system downstream from the image sensor.

In some embodiments, a surveillance system comprises one or more image sensors located after or downstream from an automated handling robot or system. In some embodiments, an image sensor provided downstream from a handling station captures one or more images of a product after being handled or placed to verify correct placement or handling. Verification may be done on products handled on an automated system or by a human handler.

In some embodiments, the surveillance system includes further sensors, such as weight sensors, motion sensors, laser scanners, or other sensors useful for gathering information related to a product or container.

### V. ANOMALY DETECTION

Systems provided herein may be configured to detect anomalies of which occur during the handling and/or processing of one or more objects. In some embodiments, a system obtains one or more properties of an object prior to being handled by a robotic manipulator and analyzes the obtained properties against one or more expected properties of the object. In some embodiments, a system obtains one or more properties of an object while being handled by a robotic manipulator and analyzes the obtained properties against one or more expected properties of the object. In some embodiments, a system obtains one or more properties of an object after being handled by a robotic manipulator and analyzes the obtained properties against one or more expected properties of the object. In some embodiments, if an anomaly is detected, the system does not proceed to place the object at a target position. The system may instead instruct a robotic manipulator to place the object at an exception position, as described herein. In some embodiments, the system may verify a registered anomaly with an operator prior to placing an object at a given position.

In some embodiments, one or more optical sensors scan a machine-readable code provided on an object. Information obtained by the machine-readable code may be used to verify that an object is in a proper location. If it is determined that an object is misplaced, the system may register an anomaly event corresponding to a misplacement of said object. In some embodiments, the system generates an alert if an anomaly event is registered.

### VI. HUMAN IN THE LOOP

In some embodiments, the system communicates with an operator or other user. The system may communicate with an operator using a computing device. The computing device may be an operator device. The computing device may be configured to receive input from an operator or user with a user interface. The operator device may be provided at a location remote from the handling system and operations.

In some embodiments, an operator utilizes an operator device connected to the system to verify one or more anomaly events or alerts generated by the system. In some embodiments, the operator device receives captured images from one or more image sensors of the system to verify that an anomaly has occurred in an object. An operator may provide verification that an object has been misplaced or that an object has been damaged based on the one or more images captured by the system and communicated to the operator device.

In some embodiments, captured images are provided in a module to be displayed on a screen of an operator device. In some embodiments, the module displays the one or more captured images adjacent to one or more reference images corresponding to said object. In some embodiments, one or more captured images are displayed on a page adjacent to a page displaying one or more reference images.

In an embodiment, an operator uses an interface of the operating device to verify that an anomaly event or alert was correctly generated. Verification provided by the operator may be used to train a machine learning algorithm, as disclosed herein. In some embodiments, verification that an alert was correctly generated adjusts a predetermined threshold which is used to generate an alert if a difference between one or more measured properties and one or more corresponding expected properties of an object exceeds said predetermined threshold. In some embodiments, verification that an alert was incorrectly generated adjusts a predetermined threshold which is used to generate an alert if a difference between one or more measured properties and one or more corresponding expected properties of an object exceeds said predetermined threshold.

In some embodiments, verification of an alert instructs a robotic manipulator to handle an object in a particular manner. For example, if an anomaly alert corresponding to an object is verified as being correctly generated, the robotic manipulator may place the object at an exception location. In some embodiments, if an anomaly alert corresponding to an object is verified as being incorrectly generated, the robotic manipulator may place the object at a target location. In some embodiments, if an alert is generated and an operator verifies that two or more objects are unintentionally being handled simultaneously, then the robotic manipulator performs a wiggling motion in an attempt to separate the two or more objects.

In some embodiments, one or more images of a target container or target location wherein one or more objects are provided at are transmitted to an operator or user device. An operator or user may then verify that the one or more objects are correctly placed at the target location or with a target container. A user or operator may also provide feedback using an operator or user device to communicate errors if the one or more objects have been incorrectly placed at the target location or within the target container.

In some embodiments, it may be determined that human intervention is required for proper handling of an object type. In some embodiments, a specific product may require manual handling or packaging by human operators. As disclosed herein, a database may provide information as to which products requires human intervention or handling. In some embodiments, a warehouse surveillance or monitoring system alerts human handlers to incoming products which require human intervention. In some embodiments, upon detection of a product requiring human intervention, the system routes said product or a container holding said product to a station designated for human intervention. Said station may be separated from automated handling systems or robotic arms. Separation may be necessary for safety reasons or to provide an accessible area for a human to handle the products.

### VII. WAREHOUSE INTEGRATION

The systems and methods disclosed herein may be implemented in existing warehouses to automate one or more processes within a warehouse. In some embodiments, software and robotic manipulators of the system are integrated with the existing warehouse systems to provide a smooth transition of manual operations being automated.

### A. Product Database

In some embodiments, a product database is provided in communication with the systems disclosed herein. The product database may comprise a library of object to be handled by the system. The product database may include properties of each objects to be handled by the system. In some embodiments, the properties of the objects provided by the product data base are expected properties of the objects. The expected properties of the objects may be compared to measured properties of the objects in order to determine if an anomaly has occurred.

Expected properties may include expected dimensions, expected forces, expected weights, and expected machine-readable codes, as disclosed herein. Product databases may be updated according to the objects to be handled by the system. Product databases may be generated input of information of the objects to be handled by handled by the system.

In some embodiments, objects may be processed by the system to generate a product database. For example, an undamaged object may be handled by one or more robotic manipulators to determine expected properties of the object. Expected properties of the object may include expected dimensions, expected forces, expected weights, and expected machine-readable codes, as disclosed herein. The expected properties determined by the system may then be input into the product database.

In some embodiments, the system may process a plurality of objects of the same type to determine a standard deviation occurring within objects of that type. The determined standard deviations may be used to set a predetermined threshold, wherein a difference between expected properties and measured properties of an object may trigger an anomaly alert. In some embodiments, the predetermined threshold includes a standard deviation of different of one or more objects of the same type. In some embodiments, the standard deviation is multiplied by a constant factor to set a predetermined threshold.

In some embodiments, the product database comprises a set of filtering criterion. The filtering criterion may be used for routing objects to a proper handling station. Filtering criterion may be used for routing objects to a robotic handling station or a human handling station. Filtering criterion may be utilized for routing objects to an appropriate robotic handing station with an automated handler suited for handling a particular object or product type.

In some embodiments, the database is continually updated. In some embodiments, the filtering criterion is continually updated. In some embodiments, the filtering criterion is updated as new handling systems are integrated within a facility. In some embodiments, the filtering criterion is updated as new product types are handlined within a facility. In some embodiments, the filtering criterion is updated as new manipulation techniques or handling patterns are realized. In some embodiments, a machine learning program is utilized to update the database and/or filtering criterion.

### B. Object Tracking

In some embodiment, the system tracks objects as they are handled. In some embodiments, the system integrates with existing tracking software of a warehouse which the system is implemented within. The system may connect with existing software such that information which is normally received by manual input is now communicated electronically by the system.

Object tracking by the system may include confirming an object has been received at a source locations or station. Object tracking by the system may include confirming an object has been placed at a target position. Object tracking by the system may include input that an anomaly has been detected. Object tracking by the system may include input that an object has been placed at an exception location. Object tracking by the system may include input that an object or target container has left a handling station or target position to be further processed at another location within a warehouse.

### VIII. INTEGRATED SOFTWARE

Many or all of the functions of a robotic device may be controlled by a control system. A control system may include at least one processor that executes instructions stored in a non-transitory computer readable medium, such as a memory. The control system may also comprise a plurality of computing devices that may serve to control individual components or subsystems of the robotic device.

In some embodiments, a memory comprises instructions (e.g., program logic) executable by the processor to execute various functions of robotic device described herein. A memory may comprise additional instructions as well, including instructions to transmit data to, receive data from, interact with, and/or control one or more of a mechanical system, a sensor system, a product database, an operator system, and/or the control system.

### A. Machine Learning Integration

In some embodiments, machine learning algorithms are implemented such that systems and methods disclosed herein become completely automated. In some embodiments, verification operations completed by a human operator are removed after training of machine learning algorithms are complete.

In some embodiments, the machine learning programs utilized incorporate a supervised learning approach. In some embodiments, the machine learning programs utilized incorporate a reinforcement learning approach. Information such as verification of alerts/anomaly events, measured properties of objects being handled, and expected properties of objects being handled by be received by a machine learning algorithm for training.

Other machine learning approaches such as unsupervised learning, feature learning, topical modeling, dimensionality reduction, and meta learning may be utilized by the system. Supervised learning may include active learning algorithms, classification algorithms, similarity learning algorithms, regressive learning algorithms, and combinations thereof.

Models used by the machine learning algorithms of the system may include artificial neural network models, decision tree models, support vector machines models, regression analysis models, Bayesian network models, training models, and combinations thereof.

Machine learning algorithms may be applied to anomaly detection, as described herein. In some embodiments, machine learning algorithms are applied to programed movement of one or more robotic manipulators. Machine learning algorithms applied to programmed movement of robotic manipulators may be used to optimize actions such as scanning a machine-readable code provided on an object. Machine learning algorithms applied to programmed movement of robotic manipulators may be used to optimize actions such performing a wiggling motion to separate unintentionally combined objects. Machine learning algorithms applied to programmed movement of robotic manipulators may be used to any actions of a robotic manipulator for handling one or more objects, as described herein. In some embodiments, machine learning algorithms are applied to make decisions whether or not to put an item on the tilter.

### B. Trajectory Optimization

In some embodiments, trajectories of items handled by robotic manipulators are automatically optimized by the systems disclosed herein. In some embodiments, the system automatically adjusts the movements of the robotic manipulators to achieve a minimum transportation time while preserving constraints on forces exerted on the item or package being transported.

In some embodiments, the system monitors forces exerted on the object as they are transported from a source position to a target position, as described herein. The system may monitor acceleration and/or rate of acceleration (i.e., jerk) of an object being transported by a robotic manipulator. The force experienced by the object as it is manipulated may be calculated using the known movement of the robotic manipulator (e.g., position, velocity, and acceleration values of the robotic manipulator as it transports the object) and force values obtained by the weight/torsion and force sensors provided on the robotic manipulator.

In some embodiments, optical sensors of the system monitor the movement of objects being transported by the robotic manipulator. In some embodiments, the trajectory of objects is optimized to minimize transportation time including scanning of a digital code on the object. In some embodiments, the optical sensors recognize defects in the objects or packaging of objects as a result of mishandling (e.g., defects caused by forces applied to the object by the robotic manipulator). In some embodiments, the optical sensors monitor the flight or trajectory of objects being manipulated for cases which the objects are dropped. In some embodiments, detection of mishandling or drops will result in adjustments of the robotic manipulator (e.g., adjustment of trajectory or forces applied at the end effector). In some embodiments, the constraints and optimized trajectory information will be stored in the product database, as described herein. In some embodiments, the constraints are derived from a history of attempts for the specific object or plurality of similar objects being transported. In some embodiments, the system is trained by increasing the speed at which an object is manipulated over a plurality of attempts until a drop or defect occurs due to mishandling by the robotic manipulator.

In some embodiments, a technician verifies that a defect or drop has occurred due to mishandling. Verification may include viewing a video recording of the object being handled and confirming that a drop or defect was likely due to mishandling by the robotic manipulator.

### C. Computer Systems

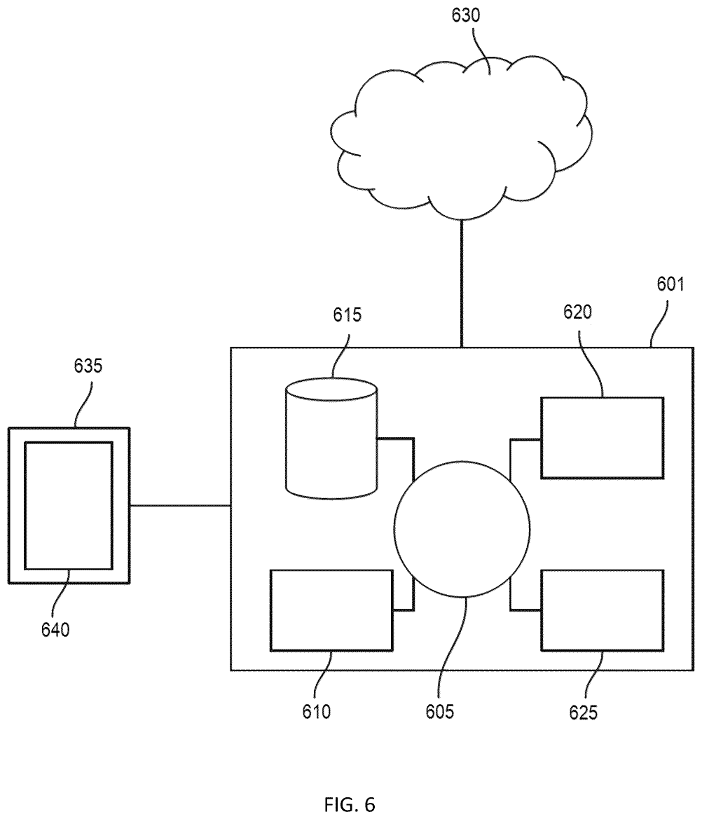

The present disclosure provides computer systems that are programmed to implement methods of the disclosure. FIG. 6 depicts a computer system 601 that is programmed or otherwise configured as a component of automated handling systems disclosed herein and/or to perform one or more operations of methods of automated handling disclosed herein. The computer system 601 can regulate various aspects of automated of the present disclosure, such as, for example, providing verification functionality to an operator, communicating with a product database, and processing information obtained from components of automated handling systems disclosed herein. The computer system 601 can be an electronic device of a user or a computer system that is remotely located with respect to the electronic device. The electronic device can be a mobile electronic device.

The computer system 601 includes a central processing unit (CPU, also “processor” and “computer processor” herein) 605, which can be a single core or multi core processor, or a plurality of processors for parallel processing. The computer system 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The computer system 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 610. The instructions can be directed to the CPU 605, which can subsequently program or otherwise configure the CPU 605 to implement methods of the present disclosure. Examples of operations performed by the CPU 605 can include fetch, decode, execute, and writeback.

The CPU 605 can be part of a circuit, such as an integrated circuit. One or more other components of the system 601 can be included in the circuit. In some cases, the circuit is an application specific integrated circuit (ASIC).

The storage unit 615 can store files, such as drivers, libraries, and saved programs. The storage unit 615 can store user data, e.g., user preferences and user programs. The computer system 601 in some cases can include one or more additional data storage units that are external to the computer system 601, such as located on a remote server that is in communication with the computer system 601 through an intranet or the Internet.

The computer system 601 can communicate with one or more remote computer systems through the network 630. For instance, the computer system 601 can communicate with a remote computer system of a user (e.g., a mediator computer). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 601 via the network 630.

Methods as described herein can be implemented by way of machine (e.g., computer processor) executable code stored on an electronic storage location of the computer system 601, such as, for example, on the memory 610 or electronic storage unit 615. The machine executable or machine readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers. processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables: copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display 635 that comprises a user interface (UI) 640 for providing, for example, health crisis management. Examples of UI's include, without limitation, a graphical user interface (GUI) and web-based user interface.

### IX. DEFINITIONS

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

The terms “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative, or quantitative and qualitative determinations. Assessing can be relative or absolute. “Detecting the presence of” can include determining the amount of something present in addition to determining whether it is present or absent depending on the context.

As used herein, the term “about” a number refers to that number plus or minus 10% of that number. The term “about” a range refers to that range minus 10% of its lowest value and plus 10% of its greatest value.

The section headings used herein are for organizational purposes only and are not to be construed as limiting the subject matter described.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. An object handling system, the object handling system comprising:
an item tilter;
a robotic handler;
an optical sensor having a field of view covering at least a portion of the item tilter; and
a software module operably coupled to the item tilter, the robotic handler, and the optical sensor, the software module configured to:
(i) analyze image data, captured by the optical sensor, corresponding to the object to determine an orientation of the object,
(ii) in response to determining the orientation of the object, instruct the item tilter to re-orient the object, and
(iii) after instructing the item tilter to re-orient the object, instruct the robotic handler to move the object from the item tilter to a destination container.

2. The object handling system of claim 1, wherein the software module is further configured to analyze, based at least in part on the image data, one or more characteristics of the object.

3. The object handling system of claim 2, wherein the software module is configured to instruct the item tilter to re-orient the object based at least in part on the analysis of the one or more characteristics of the object.

4. The object handling system of claim 2, wherein the software module is configured to instruct the robot handler to move the object from the item tilter to the destination container based at least in part on the analysis of the one or more characteristics of the object.

5. The object handling system of claim 2, wherein the software module is configured to determine the object tilter should re-orient the object based at least in part on the analysis of the one or more characteristics of the object.

6. The object handling system of claim 2, wherein the software module is further configured to determine the object should be placed on the object tilter based at least in part on the analysis of the one or more characteristics of the object.

7. The object handling system of claim 2, wherein the software module is further configured perform the analysis of the one or more characteristics of the object using a machine learning model.

8. The object handling system of claim 1, wherein the software module is configured to analyze the image data via a machine learning model.

9. The object handling system of claim 2, wherein the one or more characteristics of the object comprise one or more of: a size of the object, a weight of the object, or a shape of the object.

10. The object handling system of claim 1, wherein the software module is further configured to determine a speed at which the object should be rotated by the item tilter to re-orient the object.

11. The object handling system of claim 1, wherein the software module is further configured to cause a second object to be placed at the item tilter after the object is moved from the item tilter, but before the object is moved into the destination container.

12. The object handling system of claim 1, wherein the software module is configured to instruct the item tilter to re-orient the object in each of an X-dimension, Y-dimension, and Z-dimension.

13. The object handling system of claim 1, wherein the software module is configured to, prior to instructing the robotic handler to move the object from the item tilter to the destination container, instruct the robotic handler to affix an end effector selected based at least in part on the image data.

14. A method of packing a destination container with an object, the method comprising:
(a) providing the object to an item tilter;
(b) obtaining, via an optical sensor, image data corresponding to the object;
(c) analyzing, via one or more processors, the image data to determine an orientation of the object;
(d) in response to determining the orientation of the object, re-orienting the object, using the item tilter; and
(e) after re-orienting the object at (d), moving the object from the item tilter into the destination container.

15. The method of claim 14, wherein the object is provided to the item tilter at (a) via carried out by a conveyor belt, robotic arm, or a combination thereof.

16. The method of claim 14, wherein the object is moved from the item tilter into the destination container at (e) via a conveyor belt, robotic arm, a chute system, a pushing apparatus or a combination thereof.

17. The method of claims 14, further comprising:
(f) determining, via the one or more processors, a placement location of the object within the destination container.

18. The method of claim 14, wherein the image data comprises video data.

19. (canceled)

20. (canceled)

21. (canceled)

22. The method of claim 17, wherein determining the placement location at (f) comprises determining a speed to move the object, a force to move the object, a minimum size packaging for the object, or a combination thereof.

23. The method of claim 14, further comprising:
(f) determining, via the one or more processors, to provide the object to the item tilter.

24. The method of claim 23, wherein determining to provide the object to the item tilter at (f) is based at least in part on output from a product database corresponding to the object.

25. The object handling system of claim 1, wherein the image data comprises video data.

26.-40. (canceled)
